(19) United States
(12) Patent Application Publication
(10) Pub. No.: US 2018/0127949 A1
(43) Pub. Date: May 10, 2018

(54) HYDRAULIC CIRCUIT AND WORKING MACHINE

(71) Applicant: Caterpillar SARL, Geneva (CH)

(72) Inventor: Hideki Nakajima, Tokyo (JP)

(73) Assignee: Caterpillar SARL, Geneva (CH)

(21) Appl. No.: 15/566,622

(22) PCT Filed: Apr. 13, 2016
(86) PCT No.: PCT/EP2016/058148

§ 371 Date: Oct. 13, 2017

(30) Foreign Application Priority Data
Apr. 17, 2015 (JP) 2015-084715

(51) Int. Cl. E02F 9/22

(52) U.S. Cl. CPC E02F 9/2239; E02F 9/2225; E02F 9/2296; F15B 2211/20523; F15B 2211/20546; F15B 2211/7142; F15B 2211/30535; F15B 2211/30595; F15B 2211/50536; F15B 2211/7135; F15B 2211/20576

(57) ABSTRACT

Provided is a hydraulic circuit in which efficiency of confluence and distribution of each pump flow rate for various operations of each control valve is improved. The hydraulic circuit includes control valves (CV1) to (CV4) configured at least to control the direction of hydraulic oil respectively supplied to each cylinder (21c) to (23c) and a hydraulic swing motor (16m). The hydraulic circuit includes, at the upstream side of a bucket control valve (CV2), a second pressure compensating valve (CO2) which maintains fore and aft pressure difference at an opening from pumps (P1) to (P3) of the bucket control valve (CV2) to the bucket cylinder (23c) constant. The Hydraulic circuit includes a selector valve (29) configured to control the direction of hydraulic oil discharged from a third pump (P3) so as to selectively supply the hydraulic oil to any of the bucket cylinder (23c), the stick cylinder (22c), or the hydraulic swing motor (16m). When switching the selector valve (29) according to the degree of operation of at least one of the control valves (CV1) to (CV4), the hydraulic oil supplied to the bucket cylinder (23c) is made confluent between the bucket control valve (CV2) and the second pressure compensating valve (CO2).

### TECHNICAL FIELD

The present invention relates to a hydraulic circuit that has a plurality of pumps for supplying a working fluid to a plurality of hydraulic actuators, respectively, and a working machine provided with this hydraulic circuit.

### BACKGROUND ART

As a hydraulic circuit for converging a plurality of pump discharge flows, there has conventionally been known a hydraulic circuit that is capable of converging oil discharged from two pumps and then supplying it to a control valve of each of hydraulic actuators by using different combinations of existing pumps and control valves of a working machine such as a hydraulic excavator (see PTL 1, for example).

This configuration, however, lowers the converging and distribution efficiency of a so-called set of three simultaneous operations where the boom, stick and bucket configuring, for example, a working device of a working machine are rotary operated all at once.

In view of this circumstance, there has been proposed a hydraulic circuit that increases the efficiency and operating speed by converging and distributing the oil discharged from three pumps through use of an additional pump that supplies pressure oil to a slewing motor that slews an upper slewing body of a working machine with respect to a lower traveling body.

Specifically, for example, there have been known a configuration for increasing the operating speed of an arm cylinder that is operated by supply of pressure oil from two pumps, by converging the oil discharged from another pump supplying pressure oil to a slewing motor, with the arm cylinder (see PTL 2, for example), a configuration for selectively converging the oil discharged from a pump supplying pressure oil to a slewing motor, with a combination of a boom control valve and a bucket control valve, an arm control valve, or a bucket control valve (see PTL 3, for example), a configuration for increasing the speed of stretching an arm cylinder by converging the oil discharged from pumps, at the bottom of an arm cylinder, and for canceling the convergence of the discharged oil in accordance with the type of a complex operation, the pumps being configured to supply pressure oil to a slewing motor (see PTL 4, for example), and the like.

### CITATION LIST

### Patent Literature

### [PTL 1] Japanese Patent Application Publication No. 2012-67459

### [PTL 2] Japanese Patent Application Publication No. 2000-337307

### [PTL 3] Japanese Patent Application Publication No. 2006-200179

### [PTL 4] Japanese Patent Application Publication No. 2008-274988

### SUMMARY OF INVENTION

### Technical Problem

The configurations described in PTL 2 to PTL 4, however, cannot substantially improve the efficiency and operability, due to their configurations in which the oil that is discharged from the pumps supplying pressure oil to the slewing motor different from each cylinder is simply converged when, for example, the set of three simultaneous operations is executed.

The present invention was contrived in view of these circumstances, and an object thereof is to provide a hydraulic circuit that is designed to improve the efficiency of converging and distributing pump flows in accordance with various operations of control valves, and a working machine provided with such hydraulic circuit.

### Solution to Problem

An invention described in claim 1 is a hydraulic circuit having: first to fourth hydraulic actuators; a first pump that supplies a working fluid to each of the first and second hydraulic actuators; a second pump that supplies a working fluid to the third hydraulic actuator; a third pump that supplies a working fluid to the fourth hydraulic actuator; first to fourth control valves that control at least directions of the working fluids supplied to the first to fourth hydraulic actuators; a pressure compensating valve that is provided on an upstream side of the second control valve and keeps constant pressure difference between before and after an orifice of the second control valve that is opened between the first to third pumps and the second hydraulic actuator; and a switching valve that is switched in accordance with an operation amount of at least one of the first to fourth control valves and controls the direction of the working fluid discharged from the third pump, in such a manner that the working fluid is selectively supplied to any of the second to fourth hydraulic actuators, wherein the switching valve converges the working fluid, which is supplied to the second hydraulic actuator, between the second control valve and the pressure compensating valve.

An invention described in claim 2 is a working machine that has a machine body, a working device mounted in the machine body, and the hydraulic circuit of claim 1 that is provided in the machine body and the working device, wherein the machine body has a lower traveling body and an upper slewing body that is axially supported by the lower traveling body and slewed by a slewing motor which is the fourth hydraulic actuator, and the working device has a boom that is axially coupled to the upper slewing body and rotated by a boom cylinder which is the first hydraulic actuator, a stick that is axially coupled to a tip of the boom and rotated by a stick cylinder which is the third hydraulic actuator, and a bucket that is axially coupled to a tip of the stick and rotated by a bucket cylinder which is the second hydraulic actuator.

### Advantageous Effects of Invention

According to the invention described in claim 1, a working fluid is supplied from the first pump to the first hydraulic actuator, the second hydraulic actuator, or to both the first and second hydraulic actuators, and a working fluid is also supplied from the second pump to the third hydraulic actuator. Then, a working fluid is selectively supplied from the third pump to any of the second to fourth hydraulic actuators by switching the switching valve in accordance with the operation amount of at least one of the first to fourth control valves. In addition, the switching valve supplies the working fluid to be supplied to the second hydraulic actuator, between the pressure compensating valve and the second control valve, thereby limiting the supply of the working fluid from the first pump to the second hydraulic actuator by taking advantage of the pressure compensating valve that keeps constant pressure difference between before and after the orifice of the second control valve that is opened between the first to third pumps and the second hydraulic actuator. As a result, the efficiency of converging and distributing the pump flows with respect to various operations of the control valves can be improved without using any complicated configurations and control.

The invention described in claim 2 can improve the efficiency of converging and distributing the pump flows with respect to various operations of the control valves, as well as particularly the efficiency of the same in the set of three simultaneous operations for operating the boom, stick and bucket.

### BRIEF DESCRIPTION OF DRAWINGS

FIG. 1 is a circuit diagram showing a way of switching a switching valve of a hydraulic circuit according to an embodiment of the present invention.

FIG. 2 is a circuit diagram showing another way of switching the switching valve.

FIG. 3 is a circuit diagram showing yet another way of switching the switching valve.

FIG. 4 is a circuit diagram showing a pressure compensating valve of the hydraulic circuit.

FIG. 5 is a side view of a working machine having the hydraulic circuit.

FIG. 6 is a circuit diagram showing a part of another embodiment of the hydraulic circuit according to the present invention.

### DESCRIPTION OF EMBODIMENTS

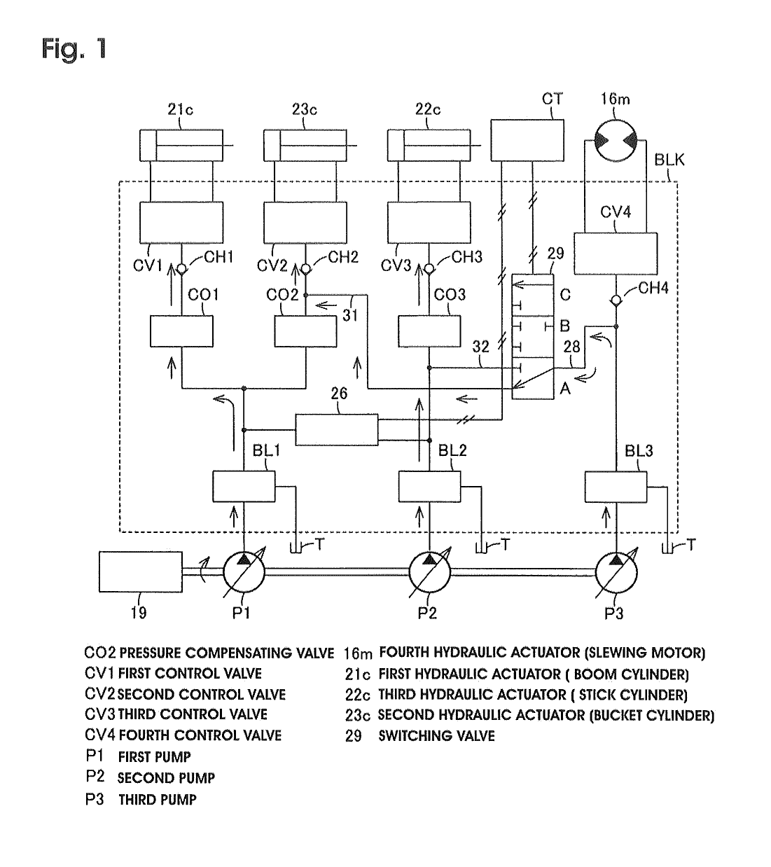

The present invention is described hereinafter in detail based on an embodiment shown in FIGS. 1 to 5 and another embodiment shown in FIG. 6.

The embodiment shown in FIGS. 1 to 5 is described first.

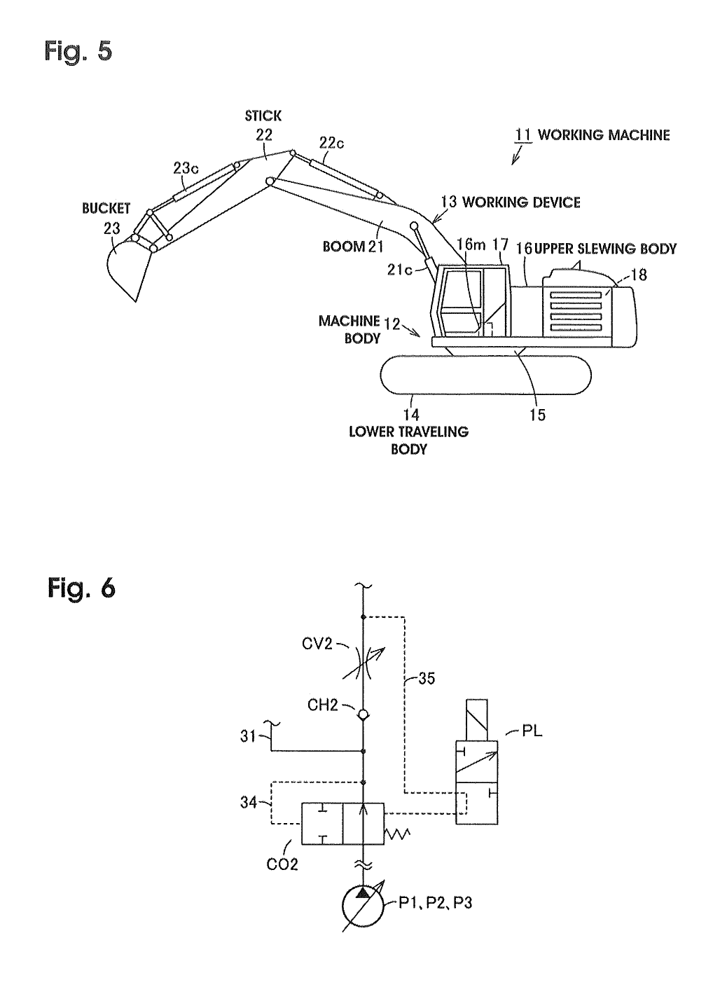

FIG. 5 shows a hydraulic excavator 11 as a working machine. The hydraulic excavator 11 is provided with a hydraulically-operated (hydraulic) machine body 12 and a hydraulically-operated (hydraulic) working device 13 mounted in this machine body 12. In the machine body 12, an upper slewing body 16 is provided on a lower traveling body 14 with a slewing bearing 15 therebetween, in such a manner as to be slewable by a slewing hydraulic motor 16m. A cab 17 configuring an operator's station and a machine room 18 are mounted in the upper slewing body 16, wherein an engine 19 shown in FIG. 1 and first to third pumps P1 to P3 driven by this engine 19 are mounted in the machine room 18.

The working device 13 has a boom 21 that is axially supported by the upper slewing body 16 and rotated by a boom cylinder 21c, a stick 22 that is axially coupled to a tip of the boom 21 and rotated by a stick cylinder 22c, and a bucket 23 that is attached to a member axially coupled to a tip of the stick 22 and rotated by a bucket cylinder 23c.

The first to third pumps P1 to P3, which are variable capacity pumps, are connected to an output shaft of the engine 19 and driven at the same rotational speed as that of the engine 19 and have the pump capacities thereof controlled by an electrical signal (such as current) of a controller CT that is set in accordance with the operation amount of an operating device such as a lever or pedal, not shown, which is provided on the inside of the operator's station. The first pump P1 supplies hydraulic oil as a working fluid to the boom cylinder 21c (a boom control valve CV1 which is the first control valve) which is the first hydraulic actuator and to the bucket cylinder 23c (a bucket control valve CV2 which is the second control valve) which is the second hydraulic actuator. The second pump P2 supplies hydraulic oil as a working fluid to the stick cylinder 22c (a stick control valve CV3 which is the third control valve) which is the third hydraulic actuator. The third pump P3 supplies hydraulic oil as a working fluid to the slewing hydraulic motor 16m (a slewing control valve CV4 which is the fourth control valve) functioning as a slewing motor, which is the fourth hydraulic actuator. The control valves CV1 to CV4 are spools or the like provided slidably in, for example, a single block BLK, control the directions and flow rates of the hydraulic oil supplied by the pumps P1 to P3, and then supply the resultant hydraulic oil to the boom cylinder 21c, the bucket cylinder 23c, the stick cylinder 22c, and the slewing hydraulic motor 16m. The inside of the block BLK is also provided with a spool and the like for controlling the directions and flow rates of hydraulic oil to be supplied to left and right traveling hydraulic motors (not shown) that are provided in, for example, the lower traveling body 14 of the machine body 12. However, FIGS. 1 to 3 only show a circuit for the cylinders 21c to 23c and slewing hydraulic motor 16m and omits the illustration of other circuits.

Specifically, a first pressure compensating valve CO1 and a second pressure compensating valve CO2 which is the pressure compensating valve are connected in parallel to a discharge port of the first pump P1 by a first bleed-off valve BL1 provided for controlling a circuit pressure. In addition, the boom control valve CV1 is connected to the first pressure compensating valve CO1 by a first check valve CH1 provided for the purpose of backflow prevention. The bucket control valve CV2 is connected to the second pressure compensating valve CO2 by a second check valve CH2 provided for the purpose of backflow prevention.

A third pressure compensating valve CO3 is connected to a discharge port of the second pump P2 by a second bleed-off valve BL2 provided for controlling the circuit pressure, and the stick control valve CV3 is connected to this third pressure compensating valve CO3 by a third check valve CH3 provided for the purpose of backflow prevention. The discharge port of the second pump P2 and the discharge port of the first pump P1 are connected to each other by a converging valve 26 at the upstream side of the first and second pressure compensating valves CO1, CO2 and of the third pressure compensating valve CO3 (the downstream side of the second bleed-off valve BL2 and the first bleed-off valve BL1).

The slewing control valve CV4 is connected to a discharge port of the third pump P3 by a third bleed-off valve BL3 provided for controlling the circuit pressure and a fourth check valve CH4 provided for the purpose of backflow prevention. A switching valve 29 is also connected to the discharge port of the third pump P3 by a channel 28 that branches off between the third bleed-off valve BL3 and the fourth check valve CH4. The control valves CV2, CV3 are connected to this switching valve 29 by channels 31, 32 respectively.

Displacements of the control valves CV1 to CV4 are controlled by pilot secondary pressure oil that is decompressed by a manual pilot-operated valve (not shown) that links pilot primary pressure oil supplied from each pilot pump (not shown) with an operation of the operating device.

The bleed-off valves BL1 to BL3 bleed off the excess hydraulic oil discharged from the first to third pumps P1 to P3, into a tank T.

The pressure compensating valves CO1 to CO3 are located on the upstream side of the control valves CV1 to CV3 and configured to keep constant pressure difference between before and after the orifices of the control valves CV1 to CV3 that are opened between the first to third pumps P1 to P3 and the hydraulic actuators (the boom cylinder 21c, the bucket cylinder 23c, the stick cylinder 22c, and the slewing hydraulic motor 16m) and to send the hydraulic oil in an amount according to the orifices of the control valves CV1 to CV3. In the present embodiment, the pressure compensating valves CO1 to CO3 are connected to a pressure difference detection line 34 connected to the upstream side of the control valves CV1 to CV3 and to a pressure difference detection line 35 connected to the downstream side of the control valves CV1 to CV3, as shown in FIG. 4, and are controlled in such a manner that the difference between the pressures detected by these pressure difference detection lines 34, 35 is kept constant.

Returning to FIG. 1, the converging valve 26 converges at least some of the hydraulic oil discharged from either one of the first and second pumps P1, P2 with the hydraulic oil discharged from the other. The converging valve 26 is operated by an electrical signal (such as current) input from the controller CT in accordance with an operation of the operating device, i.e., the operation amount of at least one of the control valves CV1 to CV4 or, in the present embodiment, the operation amount of each of the control valves CV1 to CV4.

The channel 31 connects a position between the second pressure compensating valve CO2 and the bucket control valve CV2 to the switching valve 29. In other words, using this channel 31, the switching valve 29 connects the discharge port of the third pump P3 to the downstream side of the second pressure compensating valve CO2 via the third bleed-off valve BL3, so that the hydraulic oil discharged from the third pump P3 can be supplied to the bucket cylinder 23c (the bucket control valve CV2).

The channel 32 connects a position between the third pressure compensating valve CO3 and the discharge port of the second pump P2 (the second bleed-off valve BL2) to the switching valve 29. In other words, using this channel 32, the switching valve 29 connects the discharge port of the third pump P3 to the upstream side of the third pressure compensating valve CO3 via the third bleed-off valve BL3, so that at least some of the hydraulic oil discharged from the third pump P3 can be converged with the hydraulic oil that is supplied from the second pump P2 to the stick cylinder 22c (the stick control valve CV3).

The switching valve 29 can be switched between three positions: a blocking position A that blocks the channel 28 and the channels 31, 32; a first communication position B that makes the channel 28 communicate with the channel 31; and a second communication position C that makes the channel 28 communicate with the channel 32. The switching valve 29 is operated by an electrical signal (such as current) input from the controller CT in accordance with an operation of the operating device, i.e., the operation amount of at least either one of the control valves CV1 and CV2 or, in the present embodiment, the operation amount of each of the control valves CV1 to CV4.

The bleed-off valves BL1 to BL3, the converging valve 26, the switching valve 29, the pressure compensating valves CO1 to CO3, the check valves CH1 to CH4, and the control valves CV1 to CV4 are incorporated in the single block BLK, configuring a composite valve.

The operations of the illustrated embodiment are described next.

For example, in a set of three simultaneous operations for operating the boom 21, the stick 22, and the bucket 23, including, for example, a dumping operation in which a stick-out operation for rotating the stick 22 away from the cab 17 while lifting the boom 21 and a bucket-in operation for pulling the bucket 23 toward the stick 22 are performed, the switching valve 29 is switched to the first communication position B in response to an electrical signal from the controller CT, whereby the pressure oil discharged from the first pump P1 and having its pressure adjusted by the first bleed-off valve BL1 has its pressure compensated by the first pressure compensating valve CO1, and then the resultant pressure oil is supplied to the boom cylinder 21c through the first check valve CH1 and the boom control valve CV1, as shown in FIG. 1. Furthermore, the pressure oil discharged from the second pump P2 and having its pressure adjusted by the second bleed-off valve BL2 has its pressure compensated by the third pressure compensating valve CO3, and the resultant pressure oil is supplied to the stick cylinder 22c through the third check valve CH3 and the stick control valve CV3. In addition, the pressure oil discharged from the third pump P3 and having its pressure adjusted by the third bleed-off valve BL3 passes through the channel 28, the switching valve 29, and the channel 31, and converges at the downstream side of the second pressure compensating valve CO2. At this moment, by taking advantage of the fact that the second pressure compensating valve CO2 is operated such that the pressure difference between before and after the orifice of the bucket control valve CV2 that is opened between the third pump P3 and the bucket cylinder 23c is kept constant, the pressure difference being detected by the pressure difference detection lines 34, 35 (FIG. 4), and such that the pressure oil in an amount according the orifice of the bucket control valve CV2 flows, whereby the second pressure compensating valve CO2 is closed when an excessive amount of oil is supplied through the channel 31, the amount of hydraulic oil converging through the channel 31 is made greater than the amount of hydraulic oil that tries to pass through the second pressure compensating valve CO2, and consequently, the second pressure compensating valve CO2 is closed automatically without using any additional control solenoid valve. As a result, the pressure oil from the first pump P1 flows toward the boom cylinder 21c through the boom control valve CV1, and basically only the pressure oil from the third pump P3 is supplied to the bucket cylinder 23c through the second check valve CH2 and the bucket control valve CV2. Therefore, the boom cylinder 21c (the boom control valve CV1), the bucket cylinder 23c (the bucket control valve CV2), and the stick cylinder 22c (the stick control valve CV3) are independently supplied with the pressure oil from the first pump P1, the third pump P3, and the second pump P2 respectively. The boom control valve CV1, the bucket control valve CV2, and the stick control valve CV3 control the directions and flow rates of the pressure oil to be supplied to the boom cylinder 21c, the bucket cylinder 23c, and the stick cylinder 22c, thereby rotating the boom 21, the stick 22, and the bucket 23 (FIG. 5).

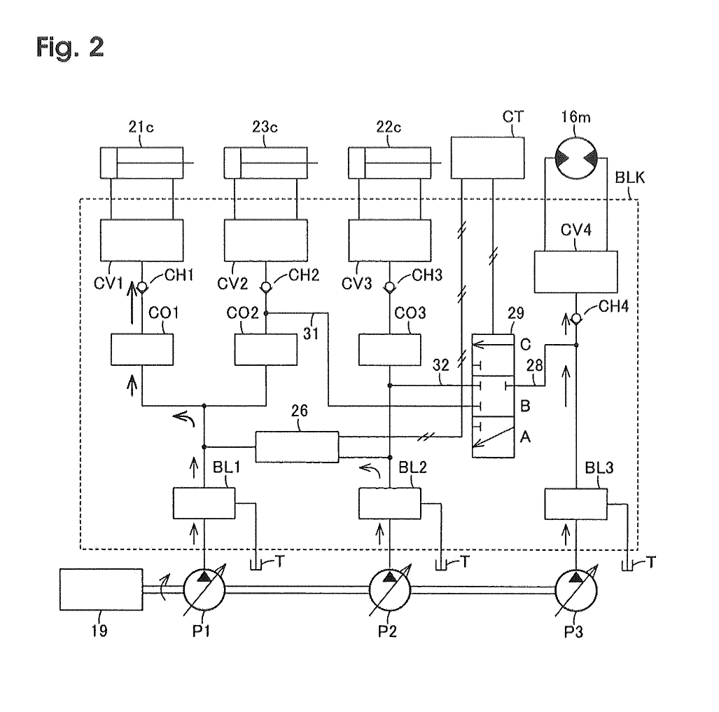

In a set of two simultaneous operations such as a so-called lifting and slewing operation for slewing the upper slewing body 16 with respect to the lower traveling body 14 while lifting the boom 21, when a relatively large amount of hydraulic oil is necessary to operate one of them (the boom 21), the switching valve 29 is switched to the blocking position A in response to an electrical signal from the controller CT, whereby the pressure oil discharged from the first pump P1 and having its pressure adjusted by the first bleed-off valve BL1 has its pressure compensated by the first pressure compensating valve CO1, and then the resultant pressure oil is supplied to the boom cylinder 21c through the first check valve CH1 and the boom control valve CV1, as shown in FIG. 2. At this moment, the converging valve 26 is switched to its open position in response to an electrical signal of the controller CT, whereby the pressure oil from the second pump P2 and having its pressure adjusted by the second bleed-off valve BL2 converges with the pressure oil from the first pump P1 through the converging valve 26 and is supplied to the boom cylinder 21c through the boom control valve CV1. The pressure oil discharged from the third pump P3 and having its pressure adjusted by the third bleed-off valve BL3 is supplied to the slewing hydraulic motor 16m through the fourth check valve CH4 and the slewing control valve CV4. Therefore, the boom cylinder 21c is supplied with the pressure oil from the first and second pumps P1 and P2, and the slewing hydraulic motor 16m is supplied with the pressure oil from the third pump P3. The boom control valve CV1 and the slewing control valve CV4 control the directions and flow rates of the pressure oil supplied to the boom cylinder 21c and the slewing hydraulic motor 16m, whereby the upper slewing body 16 slews with respect to the lower traveling body 14 while the boom 21 is rotated at an accelerated speed.

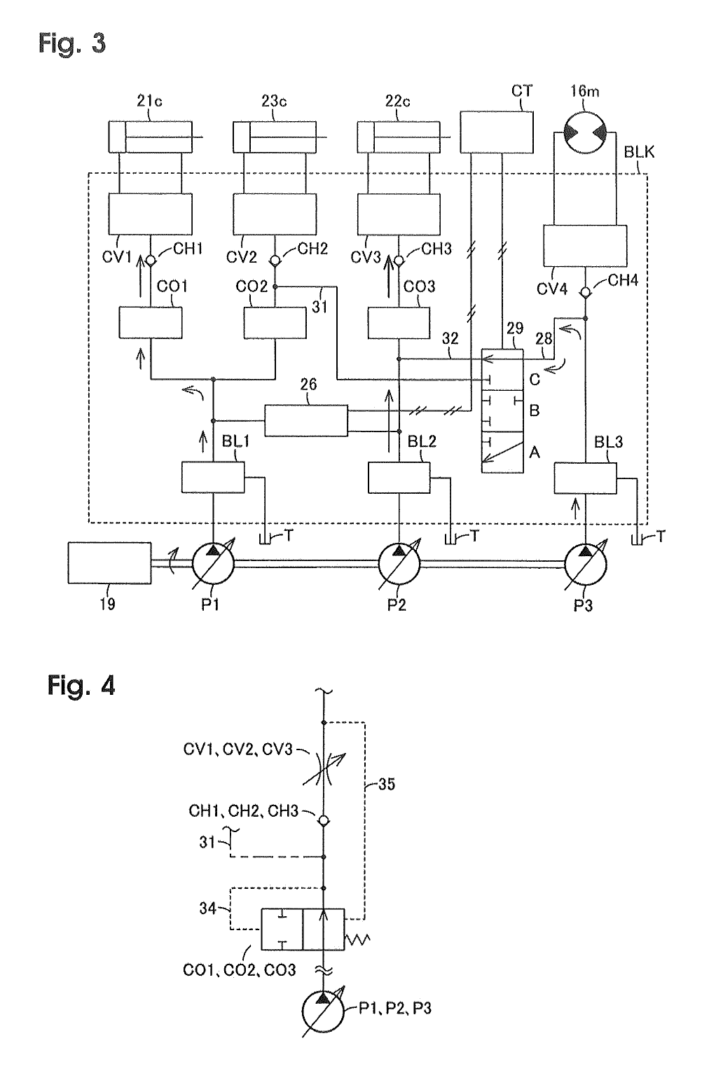

Similarly, in a set of two simultaneous operations such as a so-called stick-in operation for pulling the stick 22 toward the cab 17 while lifting the boom 21, when a relatively large amount of hydraulic oil is necessary to operate one of them (the stick 22), the switching valve 29 is switched to the second communication position C in response to an electrical signal from the controller CT, whereby the pressure oil discharged from the first pump P1 and having its pressure adjusted by the first bleed-off valve BL1 has its pressure compensated by the first pressure compensating valve CO1, and then the resultant pressure oil is supplied to the boom cylinder 21c through the first check valve CH1 and the boom control valve CV1, as shown in FIG. 3. Furthermore, the pressure oil discharged from the second pump P2 and having its pressure adjusted by the second bleed-off valve BL2 has its pressure compensated by the third pressure compensating valve CO3, and then the resultant pressure oil is supplied to the stick cylinder 22c through the third check valve CH3 and the stick control valve CV3. In addition, the pressure oil discharged from the third pump P3 and having its pressure adjusted by the third bleed-off valve BL3 passes through the channel 28, the switching valve 29, and the channel 32, and converges at the upstream side of the third pressure compensating valve CO3. Thereafter, this pressure oil has its pressure compensated by the third pressure compensating valve CO3 and is supplied to the stick cylinder 22c through the third check valve CH3 and the stick control valve CV3, together with the oil pressure discharged from the second pump P2. Therefore, the boom cylinder 21c is supplied with the pressure oil from the first pump P1, and the stick cylinder 22c is supplied with the pressure oil from the second and third pumps P2 and P3. The boom control valve CV1 and the stick control valve CV3 control the directions and flow rates of the pressure oil to be supplied to the boom cylinder 21c and the stick cylinder 22c, whereby the stick 22 is rotated at an accelerated speed while the boom 21 is rotated.

It should be noted that these switching steps are merely exemplary, and therefore the hydraulic oil can be distributed/converged in accordance with various operations by switching the switching valve 29, switching the converging valve 26, and controlling the amount of hydraulic oil discharged from the three pumps P1 to P3 in response to the electrical signals from the controller CT.

The effects of the embodiment of the present invention are listed below.

As described above, the hydraulic oil from the first pump P1 is supplied to the boom cylinder 21c, the bucket cylinder 23c, or both of the cylinders 21c, 23c, the hydraulic oil from the second pump P2 is supplied to the stick cylinder 22c, and the hydraulic oil from the third pump P3 is selectively supplied to the bucket cylinder 23c, the stick cylinder 22c or the slewing hydraulic motor 16m by switching the switching valve 29 by means of the controller CT in accordance with the operation amount of at least one of the control valves CV1 to CV4. Furthermore, when supplying the hydraulic oil to the bucket cylinder 23c, the switching valve 29, without using an additional switching valve or the like, automatically limits the supply of the hydraulic oil from the first pump P1 to the bucket cylinder 23c by taking advantage of a feature of the second pressure compensating valve CO2 that keeps constant pressure difference between before and after the orifice of the bucket control valve CV2 that is opened between the first to third pumps P1 to P3 and the bucket cylinder 23c, by supplying the hydraulic oil between the second pressure compensating valve CO2 and the bucket control valve CV2. Therefore, for example, when executing the set of three simultaneous operations for operating the boom 21, the stick 22 and the bucket 23, not only is it possible to supply the hydraulic oil from the first to third pumps P1 to P3 to the boom cylinder 21c, the bucket cylinder 23c and the stick cylinder 22c independently without relying on complicated configurations and control, but also the hydraulic oil can be distributed when one of the pump flow rates need to be high at the time of executing the set of two simultaneous operations. In this manner, the embodiment of the present invention can improve the efficiency of converging and distributing the pump flows in accordance with various operations of the control valves CV1 to CV4.

With the converging valve 26 that converges at least some of the hydraulic oil discharged from either one of the first and second pumps P1, P2 with the hydraulic oil discharged from the other, the operations can be accelerated by advancing at least some of the oil discharged from one of the first and second pumps P1, P2 to the oil discharged from the other, through switching of the converging valve 26 by means of the controller CT in accordance with the operation amount of at least one of the control valves CV1, CV2, thereby improving the efficiency of converging and distributing the pump flows in accordance with various operations of the control valves CV1 to CV4.

Consequently, an efficient circuit can be selected in accordance with various operations by using the first to third pumps P1 to P3, the second pressure compensating valve CO2, the switching valve 29, and the converging valve 26, improving the efficiency and operability.

Also, by providing the foregoing hydraulic circuit to the hydraulic excavator 11, the efficiency of converging and distributing the pump flows in accordance with various operations of the control valves CV1 to CV4 can be improved, and particularly the efficiency of the set of three simultaneous operations for operating the boom 21, the stick 22, and the bucket 23 can be improved.

Another embodiment shown in FIG. 6 is described next.

In this embodiment, the second pressure compensating valve CO2 is connected to the pressure difference detection line 34 that is connected to the upstream side of the bucket control valve CV2 and the pressure difference detection line 35 that is connected to the downstream side of the bucket control valve CV2 by a solenoid switching valve PL, wherein the difference between pressures detected by these pressure difference detection lines 34, 35 is kept constant. The solenoid switching valve PL forcibly closes the second pressure compensating valve CO2 in response to, for example, an electrical signal (such as current) from the controller CT.

When the second pressure compensating valve CO2 is forcibly closed, for example, a lot of the hydraulic oil discharged from the first pump P1 or the second pump P2 can be supplied intentionally to the boom cylinder 21c in place of the bucket cylinder 23c by using the solenoid switching valve PL, further improving the efficiency of converging and distributing the pump flows in accordance with various operations of the control valves CV1 to CV4.

The hydraulic circuit according to each of the embodiments described above can be employed by a hydraulic circuit of an apparatus other than working machines. The first hydraulic actuator is configured as the boom cylinder 21c, the second hydraulic actuator as the bucket cylinder 23c, the third hydraulic actuator as the stick cylinder 22c, and the fourth hydraulic actuator as the slewing hydraulic motor 16m, but various other hydraulic actuators can be employed as the first to fourth hydraulic actuators if necessary.

### INDUSTRIAL APPLICABILITY

The present invention is industrially applicable to all businesses that are concerned in manufacturing, sales and the like of working machines equipped with hydraulic circuits.

### REFERENCE SIGNS LIST

CO2 Second pressure compensating valve as pressure compensating valve
CV1 Boom control valve as first control valve
CV2 Bucket control valve as second control valve
CV3 Stick control valve as third control valve
CV4 Slewing control valve as fourth control valve
P1 First pump
P2 Second pump
P3 Third pump
11 Hydraulic excavator as working machine
12 Machine body
13 Working device
14 Lower traveling body
16 Upper slewing body
16m Slewing hydraulic motor as slewing motor which is fourth hydraulic actuator
21 Boom
21c Boom cylinder as first hydraulic actuator
22 Stick
22c Stick cylinder as third hydraulic actuator
23 Bucket
23c Bucket cylinder as second hydraulic actuator
29 Switching valve

1. A hydraulic circuit, comprising:
first to fourth hydraulic actuators;
a first pump that supplies a working fluid to each of the first and second hydraulic actuators;
a second pump that supplies a working fluid to the third hydraulic actuator;
a third pump that supplies a working fluid to the fourth hydraulic actuator;
first to fourth control valves that control at least directions of the working fluids supplied to the first to fourth hydraulic actuators;
a pressure compensating valve that is provided on an upstream side of the second control valve and keeps constant a pressure difference between before and after an orifice of the second control valve that is opened between the first to third pumps and the second hydraulic actuator; and
a switching valve that is switched in accordance with an operation amount of at least one of the first to fourth control valves and controls the direction of the working fluid discharged from the third pump, in such a manner that the working fluid is selectively supplied to any of the second to fourth hydraulic actuators,
wherein the switching valve converges the working fluid, which is supplied to the second hydraulic actuator, between the second control valve and the pressure compensating valve.

2. A working machine, comprising:
a machine body;
a working device mounted in the machine body; and
the hydraulic circuit according to claim 1 that is provided in the machine body and the working device,
wherein the machine body has:
a lower traveling body; and
an upper slewing body that is axially supported by the lower traveling body and slewed by a slewing motor which is the fourth hydraulic actuator, and
the working device has:
a boom that is axially coupled to the upper slewing body and rotated by a boom cylinder which is the first hydraulic actuator;
a stick that is axially coupled to a tip of the boom and rotated by a stick cylinder which is the third hydraulic actuator; and
a bucket that is axially coupled to a tip of the stick and rotated by a bucket cylinder which is the second hydraulic actuator.
